(19) United States
(12) Patent Application Publication
(10) Pub. No.: US 2014/0129252 A1
(43) Pub. Date: May 8, 2014

(54) BIOLOGICAL INFORMATION MEASUREMENT SYSTEM

(71) Applicants: Maki Inoue, Kyoto (JP); Tomonori Inoue, Kyoto (JP)

(72) Inventors: Maki Inoue, Kyoto (JP); Tomonori Inoue, Kyoto (JP)

(73) Assignee: OMRON HEALTHCARE CO., LTD., Muko-shi, Kyoto (JP)

(21) Appl. No.: 14/119,992

(22) PCT Filed: May 31, 2012
(86) PCT No.: PCT/JP2012/064102

§ 371 Date: Nov. 25, 2013

(30) Foreign Application Priority Data
Jul. 13, 2011 (JP) 2011-154665

(51) Int. Cl. G06F 19/00

(52) U.S. Cl. CPC G06F 19/3418
USPC 705/2

(57) ABSTRACT

A biological information measurement system measures a plurality of types of biological information of a specific patient, selects recording biological information that is to be kept as a record of each type of biological information from the plurality of types of measured biological information based on a predetermined selection standard, and records the selected recording biological information so that the recording biological information can be confirmed later. As a result, highly-reliable biological information can be recorded efficiently and with certainty.

### TECHNICAL FIELD

This invention, relates to biological information measurement systems, and particularly relates to biological information measurement systems suited to recording biological information.

### BACKGROUND ART

In biological information measurement tasks such as taking the temperature of a patient hospitalized in a hospital ward, when multiple pieces of biological information (blood pressure, body temperature, and transdermal arterial oxygen saturation (SpO2), for example) obtained from multiple corresponding biological information measurement devices that measure biological information (a blood pressure meter, a thermometer, and a pulse oximeter, for example) are to be recorded, it is most common for the biological information to be read visually from the biological information measurement devices and written by hand onto a paper record or the like, after which the biological information recorded in the paper record is inputted into a system such as an electronic medical record system.

There has also been a system that saves medical information inputted through a pen-type pointing device or the like (for example, see paragraph [0075] and FIG. 14 of JP H9-171528 A (called “Patent Literature 1” hereinafter)).

### CITATION LIST

### Patent Literature

Patent Literature 1: JP H9-171528 A

### SUMMARY OF INVENTION

### Technical Problem

However, in the aforementioned most common method, it is necessary to read and write information multiple times to record a single piece of biological information, and there have thus been several problems with such methods; namely, not only can an operator forget to record biological information, record erroneous biological information, and so on, but moreover, it is necessary to input information that has already been recorded by hand into the system, resulting in twice the work and a corresponding amount of time being wasted.

Meanwhile, the technique of Patent Literature 1 has a problem in that if the person inputting the information makes an erroneous input, information containing that error will be saved.

Having been achieved in light of the aforementioned problems, it is an object of this invention to provide a biological information measurement system capable of recording highly-reliable biological information efficiently and with certainty.

### Solution to Problem

To solve the aforementioned problems, a biological information measurement system according to an aspect of the invention is a system that measures biological information of a patient, and includes: a plurality of measurement units that measure a plurality of types of biological information of a specific patient; a selection unit that selects, from the plurality of types of biological information measured by the measurement units, recording biological information that is to be kept as a record of each type of biological information, based on a predetermined selection standard; and a recording unit that records the recording biological information selected by the selection unit so that the recording biological information can be confirmed later.

Preferably, the biological information measurement system further includes a confirmation acceptance unit that accepts an input confirming whether or not to record the recording biological information selected by the selection unit. Furthermore, the recording unit records the recording biological information for which an input indicating confirmation has been accepted by the confirmation acceptance unit.

Preferably, the selection unit selects the biological information based on a selection standard in which the most recent biological information is selected from each type of biological information on a time span-by-time span basis.

Preferably, the biological information measurement system further includes a calculating unit that calculates a reliability of the biological information measured by the measurement unit, and the selection unit selects the biological information based on a selection standard in which biological information whose reliability calculated by the calculating unit is greater than or equal to a predetermined value is selected.

Preferably, the biological information measurement system includes a plurality of measurement devices that each include the measurement unit, and a server that includes the recording unit.

Preferably, the biological information measurement system includes a plurality of measurement devices that each include the measurement unit, and one of the measurement devices further includes the selection unit.

More preferably, the measurement devices include a time measurement function-equipped measurement device and a time measurement function-unequipped measurement device; the time measurement function-equipped measurement device further includes a time measurement unit that identifies a time at which the biological information is measured by the measurement unit; and of the recording biological information selected by the selection unit, the recording unit records the time identified by the time measurement unit as a measurement time of the recording biological information measured by the measurement unit of the time measurement function-equipped measurement device and records the time identified by the time measurement unit as a measurement time of the recording biological information measured by the measurement unit of the time measurement function-unequipped measurement device.

More preferably, the measurement devices include a time measurement function-equipped measurement device and a time measurement function-unequipped measurement device; the time measurement function-equipped measurement device further includes a time measurement unit that identifies a time at which the biological information is measured by the measurement unit; and of the recording biological information selected by the selection unit, the recording unit records the time identified by the time measurement unit as a measurement time of the recording biological information measured by the measurement unit of the time measurement function-equipped measurement device and records a time at which the biological information is sent from the time measurement function-unequipped measurement device to the time measurement function-equipped measurement device as a measurement time of the recording biological information measured by the measurement unit of the time measurement function-unequipped measurement device.

### Advantageous Effects of Invention

According to the biological information measurement system of this invention, a plurality of types of biological information of a specific patient are measured, recording biological information that is to be kept as a record of each type of biological information is selected from the plurality of types of measured biological information based on a predetermined selection standard, and the selected recording biological information is recorded so that the recording biological information can be confirmed later.

As a result, a biological information measurement system capable of recording highly-reliable biological information efficiently and with certainty can be provided.

### BRIEF DESCRIPTION OF DRAWINGS

FIG. 1 is a diagram illustrating the system configuration of a biological information measurement system according to a first embodiment of the invention.

FIG. 2 is a block diagram illustrating the overall configuration of a biological information measurement device included in the biological information measurement system according to the first embodiment.

FIG. 3 is a block diagram illustrating the overall configuration of a server included in the biological information measurement system according to the first embodiment.

FIG. 4 is a flowchart illustrating the flow of a recorded information finalizing process executed by a host biological information measurement device according to the first embodiment.

FIG. 5 is a diagram illustrating a screen displayed in a host biological information measurement device when measurements have not been taken, according to the first embodiment.

FIG. 6 is a diagram illustrating a screen displayed in a host biological information measurement device when measurements have successfully been taken, according to the first embodiment.

FIG. 7 is a diagram illustrating a screen indicating finalizing candidates, displayed in a host biological information measurement device according to the first embodiment.

FIG. 8 is a diagram illustrating a screen indicating finalizing candidates after re-measurement, displayed in a host biological information measurement device according to the first embodiment.

FIG. 9 is a diagram illustrating a screen for confirming a finalization displayed in a host biological information measurement device, according to the first embodiment.

FIG. 10 is a diagram illustrating a screen indicating post-finalization finalizing candidates displayed in a host biological information measurement device, according to the first embodiment.

FIG. 11 is a diagram illustrating a screen indicating finalizing candidates displayed in a host biological information measurement device, according to a second embodiment.

FIG. 12 is a diagram illustrating the system configuration of a biological information measurement system according to a third embodiment.

FIG. 13 is a diagram illustrating a screen displayed in a host biological information measurement device when measurements have not been taken, according to the third embodiment.

FIG. 14 is a diagram illustrating a screen displayed in a host biological information measurement device when measurements have successfully been taken, according to the third embodiment.

FIG. 15 is a diagram illustrating a screen indicating finalizing candidates displayed in a host biological information measurement device, according to the third embodiment.

### DESCRIPTION OF EMBODIMENTS

Hereinafter, embodiments of the invention will be described in detail with reference to the drawings. Note that identical or corresponding elements in the drawings will be given the same reference numerals, and descriptions thereof will not be repeated.

### First Embodiment

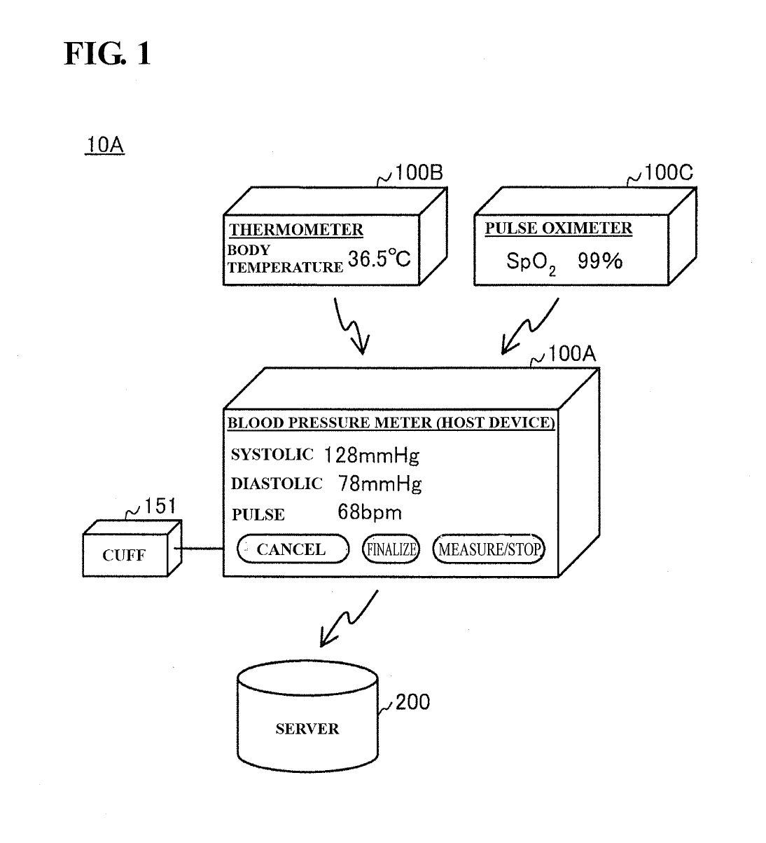

FIG. 1 is a diagram illustrating the system configuration of a biological information measurement system 10A according to a first embodiment of the invention. As shown in FIG. 1, the biological information measurement system 10A includes a blood pressure meter 100A serving as host biological information measurement device 100, a thermometer 100B, a pulse oximeter 100C, and a server 200.

The blood pressure meter 100A is a biological information measurement device 100 that measures a systolic blood pressure, a diastolic blood pressure, a pulse, and the like of a measurement subject by wrapping a cuff 151 around the measurement subject's arm.

The thermometer 100B is a biological information measurement device 100 that measures the measurement subject's body temperature. The pulse oximeter 100C is a biological information measurement device 100 that measures the measurement subject's transdermal arterial oxygen saturation (SpO2) in a non-invasive manner by attaching a probe to the measurement subject's fingertip or the like.

As will be described later, in this embodiment, biological information measured by the blood pressure meter 100A, the thermometer 100B, and the pulse oximeter 100C is collected by the blood pressure meter 100A that serves as the host biological information measurement device 100, and biological information that has been selected and finalized is then sent to and stored in the server 200.

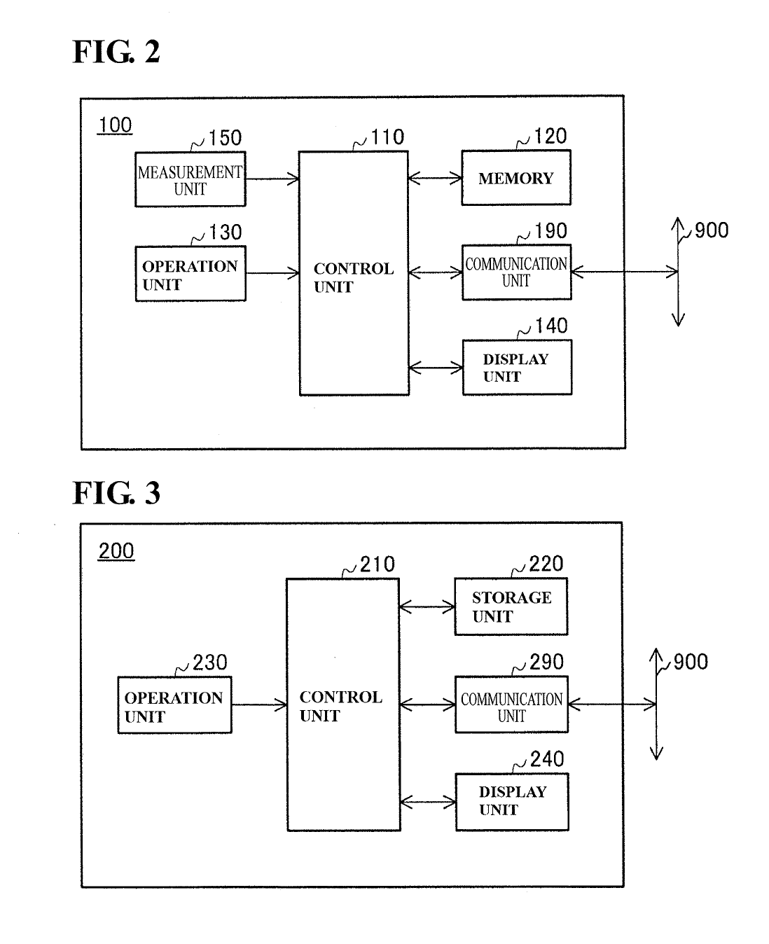

FIG. 2 is a block diagram illustrating the overall configuration of the biological information measurement device 100 included in the biological information measurement system 10A according to the first embodiment. As shown in FIG. 2, the biological information measurement devices 100 according to this embodiment, namely the blood pressure meter 100A, the thermometer 100B, and the pulse oximeter 100C, each includes a control unit 110, a memory 120, an operation unit 130, a display unit 140, a measurement unit 150, and a communication unit 190.

In response to an operational device such as an operation button or the like being manipulated by an operator, the operation unit 130 sends operation signals based on the details of the operation to the control unit 110.

The measurement unit 150 is a unit that sends detection signals obtained by a sensor to the control unit 110. In the blood pressure meter 100A, the measurement unit 150 includes the cuff 151 that has a sensor for measuring the blood pressure or the like; in the thermometer 100B, the measurement unit 150 includes a temperature measurement portion having a thermistor or an infrared light sensing circuit; and in the pulse oximeter 100C, the measurement unit 150 includes a sensor for measuring biological information, such as a probe provided with a light-emitting unit and a light-receiving unit.

The memory 120 stores data of programs for controlling the biological information measurement device 100, data used to control the biological information measurement device 100, configuration data for configuring various types of functions of the biological information measurement device 100, measurement result data, and so on. The memory 120 is also used as a working memory when programs are executed.

The control unit 110 includes a CPU (central processing unit), and controls the memory 120, the display unit 140, and the communication unit 190 in accordance with programs stored in the memory 120 for controlling the biological information measurement device 100, in response to operation signals from the operation unit 130, and based on detection signals from the measurement unit 150.

The display unit 140 includes a display panel, indicators, and the like, and displays predetermined information in accordance with control signals from the control unit 110.

The communication unit 190 sends predetermined information to an external apparatus over a communication network 900 under the control of the control unit 110, receives information from an external apparatus over the communication network 900 and passes the information to the control unit 110, and so on.

FIG. 3 is a block diagram illustrating the overall configuration of the server 200 included in the biological information measurement system 10A according to the first embodiment. As shown in FIG. 3, the server 200 according to this embodiment includes a control unit 210, a storage unit 220, an operation unit 230, a display unit 240, and a communication unit 290.

Although the communication network 900 is a LAN (local area network) in a hospital in this embodiment, the communication network 900 is not limited thereto, and may be another type of network, such as a network constructed over the Internet, or may employ one-to-one communication over a USB (Universal Serial Bus) cable or the like.

The control unit 210 includes a CPU (central processing unit) and other auxiliary circuits; the control unit 210 controls the various elements of the server 200, executes predetermined processes in accordance with programs and data stored in the storage unit 220, processes data inputted from the operation unit 230 and the communication unit 290, stores processed data in the storage unit 220, displays processed data in the display unit 240, and outputs processed data from the communication unit 290.

The storage unit 220 includes a RAM (random access memory) used as a work region required by the control unit 210 to execute programs, and a ROM (read-only memory) for storing basic programs to be executed by the control unit 210. A magnetic disk (an HD (hard disk), an FD (flexible disk)), an optical disc (a CD (compact disc), a DVD (digital versatile disc), a BD (Blu-ray disc)), a magneto-optical disc (MO), or a semiconductor memory (a memory card, an SSD (solid state drive)), or the like may be used as a storage medium in an auxiliary storage apparatus for complementing the storage region of the storage unit 220.

The operation unit 230 is configured of a keyboard and a mouse, and sends operation signals indicating operations performed by a user to the control unit 210. Instead of or in addition to the keyboard and the mouse, the operation unit 230 may be configured of another operating device, such as a touch panel.

The display unit 240 includes a display panel (for example, an LCD (liquid-crystal display)). The display unit 240 displays a predetermined image in the display panel under the control of the control unit 210.

The communication unit 290 sends information from the control unit 210 to other apparatuses over the communication network 900, and receives and passes information sent over the communication network from another apparatus with the control unit 210.

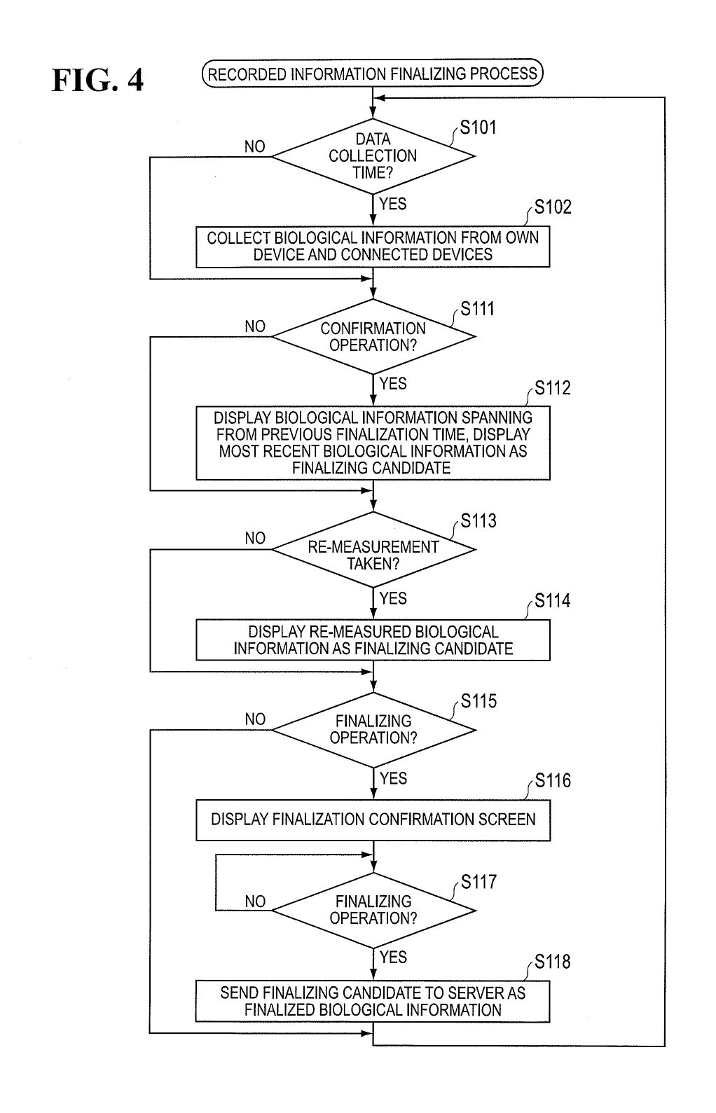

FIG. 4 is a flowchart illustrating the flow of a recorded information finalizing process executed by the host biological information measurement device 100 according to the first embodiment. As shown in FIG. 4, in step S101, the control unit 110 of the host biological information measurement device 100 (in the present embodiment, the blood pressure meter 100A) determines whether or not it is time for data to be collected (with the data collection being performed every hour, for example). In the case where it is time to perform data collection (that is, in the case where a determination of YES has been made in step S101), the control unit 110 of the host biological information measurement device 100 collects its own biological information and biological information from the other biological information measurement devices 100 connected via the communication network 900, namely the thermometer 100B and the pulse oximeter 100C.

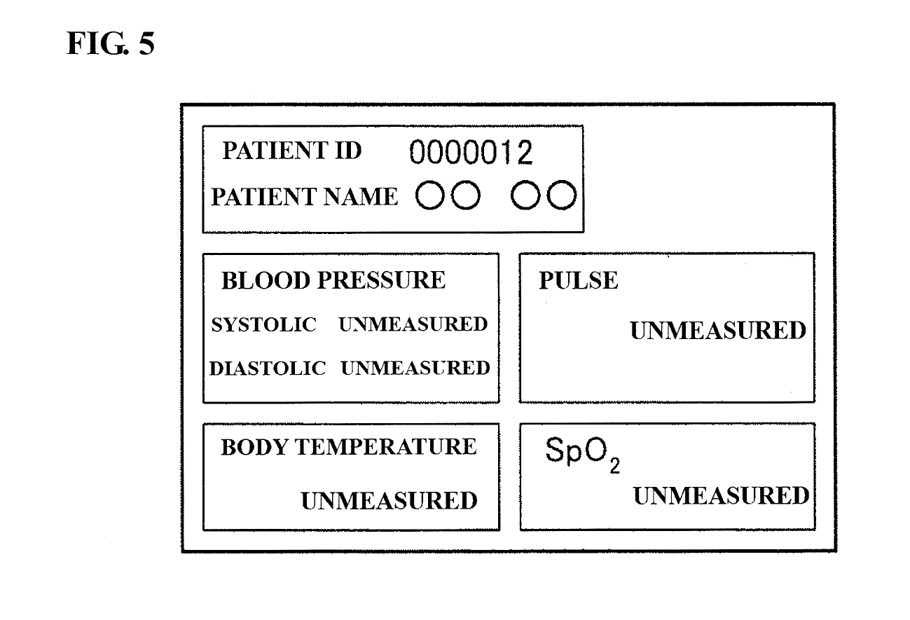

FIG. 5 is a diagram illustrating a screen displayed in the host biological information measurement device 100 when measurements have not been taken, according to the first embodiment. As shown in FIG. 5, in the case where none of the biological information measurement devices 100 have measured biological information, such as immediately after the biological information measurement devices 100 have been connected and turned on, a patient ID for identifying a patient serving as the measurement subject, a patient name, and names of respective pieces of biological information are displayed in the display unit 140 of the host biological information measurement device 100 (the blood pressure meter 100A, in the present embodiment). Text reading “not measured” is displayed in data display locations of the respective pieces of biological information.

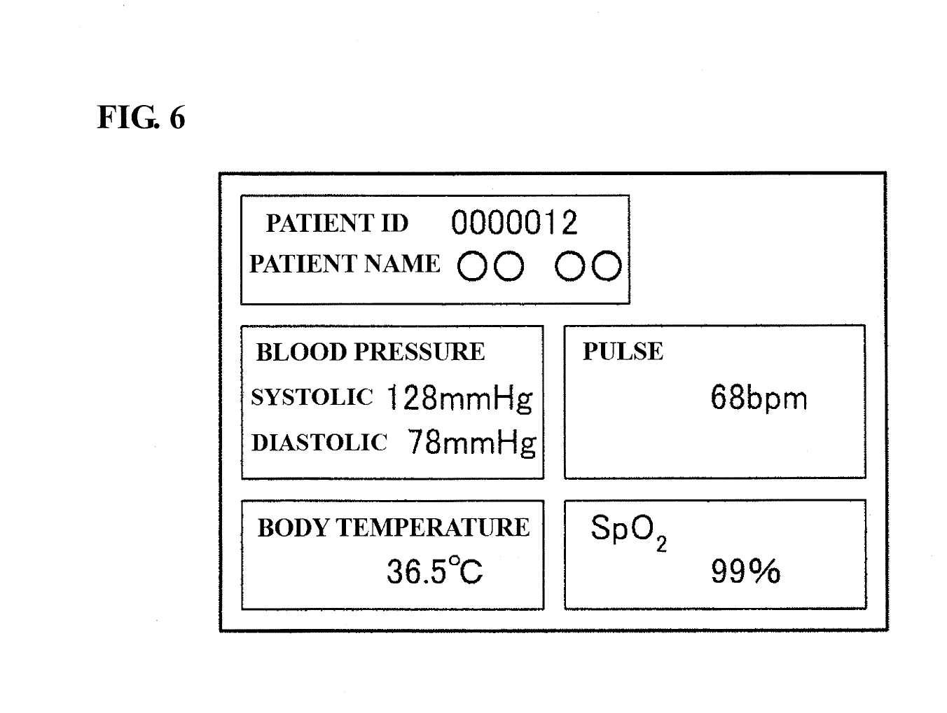

FIG. 6 is a diagram illustrating a screen displayed in the host biological information measurement device 100 when measurements have successfully been taken, according to the first embodiment. As shown in FIG. 6, when data is collected from the respective biological information measurement devices 100 in step S102 of the aforementioned FIG. 4, that biological information data is displayed in the biological information data display locations that were previously indicated as “not measured” in the display unit 140 of the host biological information measurement device 100 (the blood pressure meter 100A, in the present embodiment).

Returning to FIG. 4, in the case where it is determined that it is not time to collect data (a determination of NO in step S101), or after step S102 has been carried out, the process advances to step S111, where the control unit 110 determines whether or not an operator (a nurse, for example) has made an operation for confirming a history of the collected biological information through the operation unit 130.

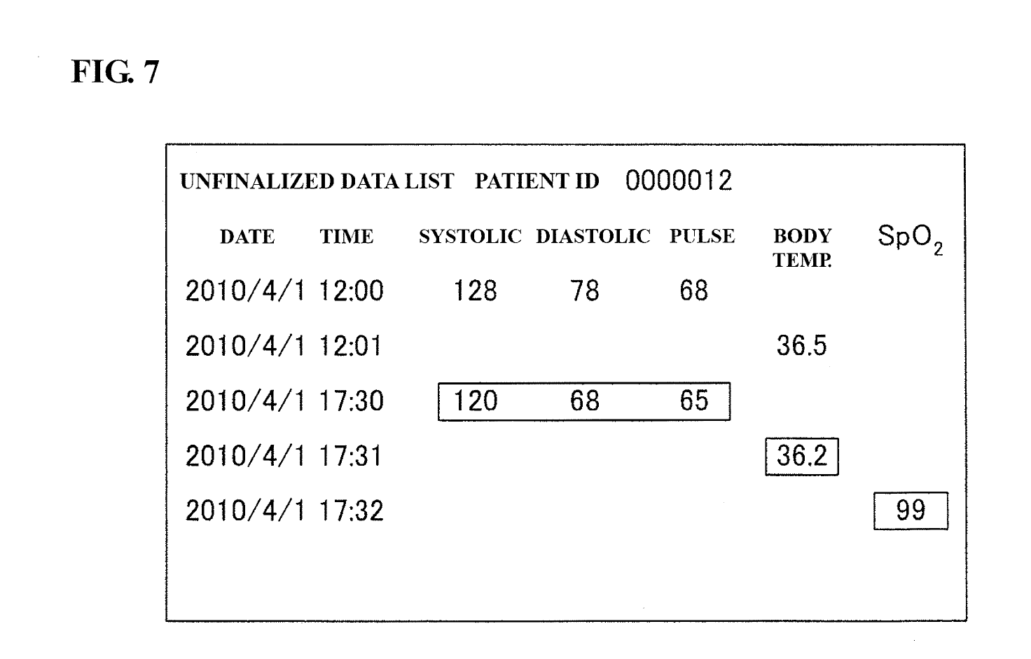

In the case where it is determined that an operation for confirming the history of the biological information has been made (that is, in the case where a determination of YES has been made in step S111), the process advances to step S112, where the control unit 110 displays the history of the collected biological information since the last time a finalizing operation was made in the display unit 140, and displays the most recent of the pieces of biological information in the history as finalizing candidates. In the present embodiment, the finalizing candidate data is displayed within frames, as indicated in FIG. 7. However, the invention is not limited thereto, and any other method may be used as long as the finalizing candidate data is displayed so as to be distinguishable from other data; for example, the text may be displayed in a different color, may be shaded, may be displayed with inverted colors, and so on.

FIG. 7 is a diagram illustrating a screen indicating finalizing candidates displayed in the host biological information measurement device 100, according to the first embodiment. In the present embodiment, the blood pressure meter 100A has a time measurement function that enables the time at which biological information has been measured to be identified. The thermometer 100B and the pulse oximeter 100C do not have time measurement functions.

As shown in FIG. 7, a first line of the history indicates that a systolic blood pressure, a diastolic blood pressure, and a pulse measured by the blood pressure meter 100A at 12:00 on Apr. 1, 2010 are 128 mmHg, 78 mmHg, and 68 bpm, respectively. A second line indicates that a body temperature received from the thermometer 100B at 12:01 on Apr. 1, 2010 is 36.5° C.

A third line indicates that a systolic blood pressure, a diastolic blood pressure, and a pulse measured by the blood pressure meter 100A at 17:30 on Apr. 1, 2010 are 120 mmHg, 68 mmHg, and 65 bpm, respectively; this data is displayed in a frame indicating that the data is the most recent data at present, and is a finalizing candidate.

A fourth line indicates that a body temperature received from the thermometer 100B at 17:31 on Apr. 1, 2010 is 36.2° C.; this data is displayed in a frame indicating that the data is the most recent data at present, and is a finalizing candidate.

A fifth line indicates that SpO2 received from the pulse oximeter 100C at 17:32 on Apr. 1, 2010 is 99%; this data is displayed in a frame indicating that the data is the most recent data at present, and is a finalizing candidate.

In the case where the operator (a nurse, for example) confirms the finalizing candidates but questions the candidates, the operator re-measures the biological information of the measurement subject using the biological information measurement device 100 that measured the questionable biological information. If the biological information measurement device 100 for which the measurement is taken again is not the host, the measured biological information is then sent to the host biological information measurement device 100.

Returning to FIG. 4, in the case where it is determined that an operation for confirming the history of the biological information has not been made (a determination of NO in step S111), or after step S112 has been carried out, the process advances to step S113, where the control unit 110 determines whether or not the data has been re-measured with that device, or whether or not re-measured data has been received from another biological information measurement device 100.

In the case where it is determined that data has been re-measured (that is, the case where a determination of YES has been made in step S113), the process advances to step S114, where the control unit 110 displays the re-measured biological information in the display unit 140 as a finalizing candidate.

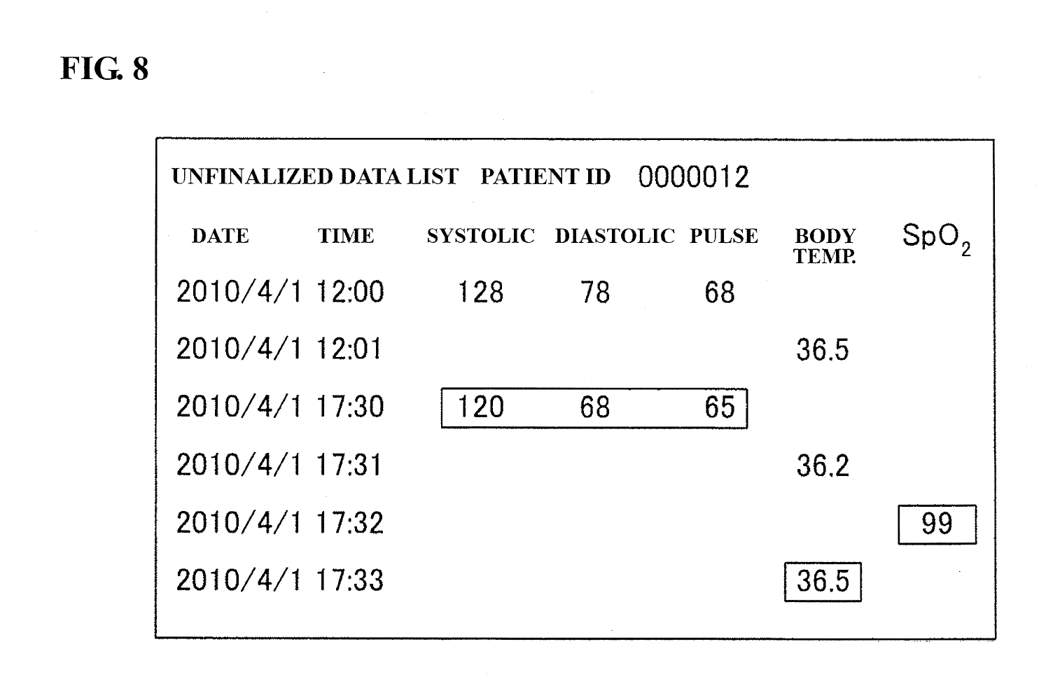

FIG. 8 is a diagram illustrating a screen indicating the finalizing candidates after re-measurement, displayed in the host biological information measurement device 100 according to the first embodiment. FIG. 8 indicates a case where, of the biological information, a body temperature of 36.2° C. in the finalization display in the fourth line of the history in FIG. 7 is questioned. In this case, the body temperature is re-measured by the thermometer 100B and the measured body temperature data is sent to the host biological information measurement device 100, that is, to the blood pressure meter 100A.

As shown in FIG. 8, the frame has been removed from the body temperature data in the third line of the finalization display in FIG. 7, and the sixth line indicates that a body temperature received from the thermometer 100B at 17:33 on Apr. 1, 2010 is 36.5° C.; this data is displayed in a frame indicating that the data is the most recent data at present, and is a finalizing candidate.

Returning to FIG. 4, in the case where it has been determined that the data has not been re-measured (that is, in the case where a determination of NO has been made in step S113), or after step S114 has been carried out, the process advances to step S115, where it is determined whether or not the operator (a nurse, for example) has made a finalizing operation for finalizing the finalizing candidate biological information through the operation unit 130.

In the case where it is determined that the finalizing operation has been carried out (that is, in the case where a determination of YES has been made in step S115), the process advances to step S116, where the control unit 110 displays a finalization confirmation screen in the display unit 140.

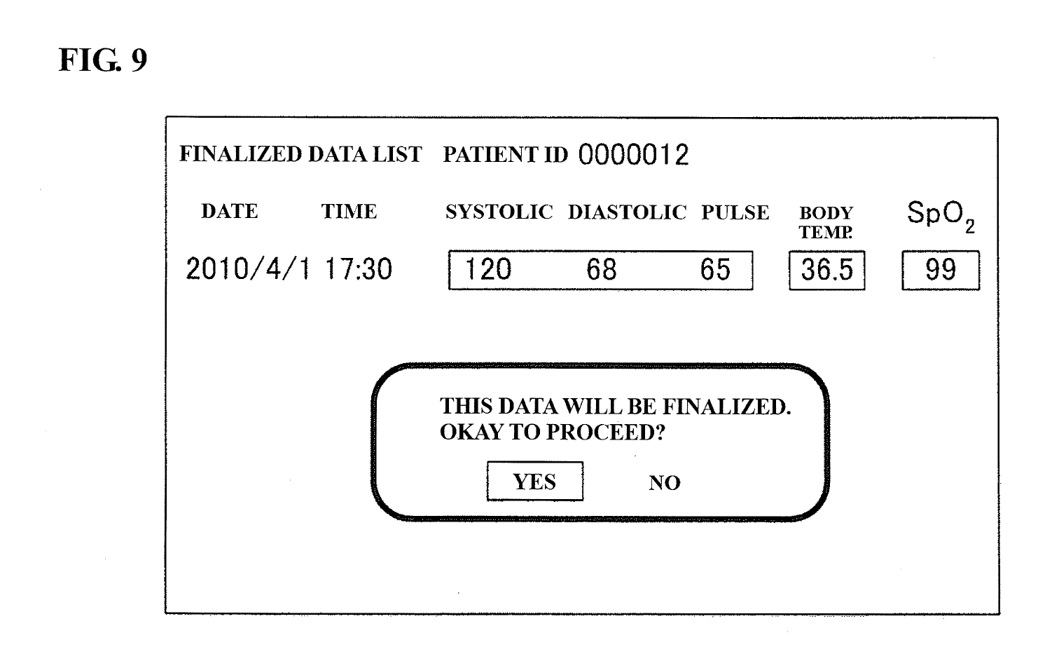

FIG. 9 is a diagram illustrating the screen for confirming the finalization displayed in the host biological information measurement device 100, according to the first embodiment. As shown in FIG. 9, the finalizing candidates illustrated in the screen shown in FIG. 8 are displayed together in a single line. Here, the time measured by the biological information measurement device 100 that has the time measurement function serves as a representative time. A display for confirming whether or not it is acceptable to finalize the finalizing candidate biological information is included in the finalization confirmation screen.

Returning to FIG. 4, in step S117, the control unit 110 determines whether or not the operator (a nurse, for example) has made a finalizing operation for finalizing the finalizing candidate biological information through the operation unit 130 while the finalization confirmation screen is being displayed. In the case where it is determined that the finalizing operation has not been made (that is, in the case where a determination of NO has been made in step S117), the control unit 110 repeats the process of step S117.

On the other hand, in the case where it is determined that the finalizing operation has been made (that is, in the case where a determination of YES has been made in step S117), the process advances to step S118, where the control unit 110 controls the communication unit 190 to send the finalizing candidate biological information as finalized biological information of that measurement subject to the server 200 over the communication network 900.

In the case where it has been determined that the finalizing operation has not been made while the finalization confirmation screen is displayed (that is, in the case where a determination of NO has been made in step S115), or after step S118 has been carried out, the control unit 110 returns the processing being executed to the process of step S101.

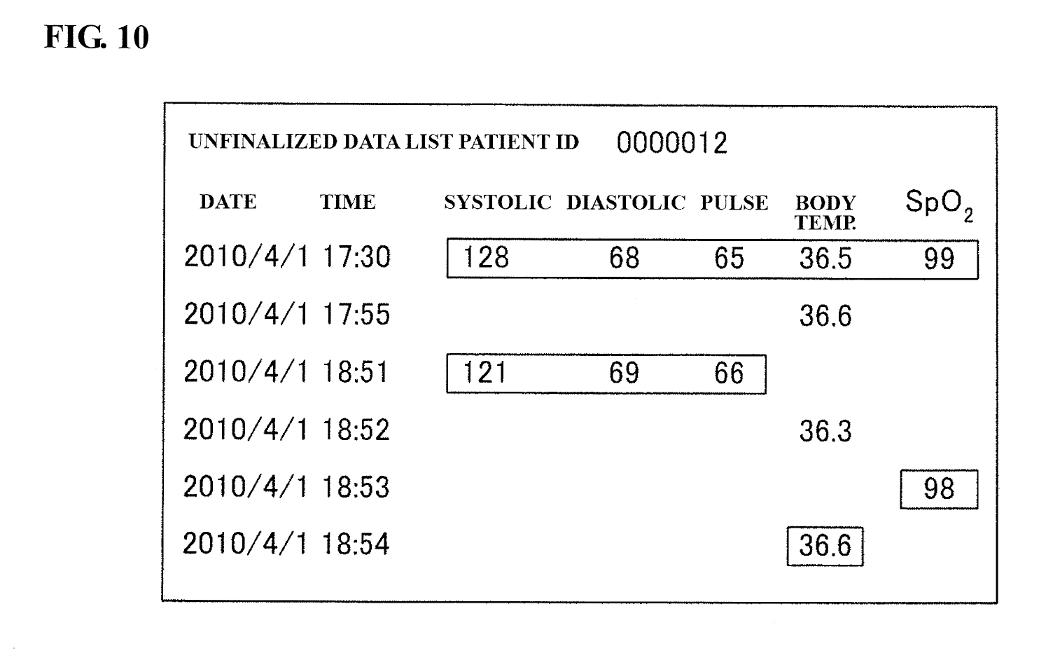

FIG. 10 is a diagram illustrating a screen indicating post-finalization finalizing candidates displayed in the host biological information measurement device 100, according to the first embodiment. As shown in FIG. 10, when it is determined in step S111 that the finalizing operation has been made after the finalized biological information has been sent to the server 200, the finalized biological information that was finalized previously is displayed in the first line until the post-finalizing operation history has reached a number of items that can be displayed in the screen.

According to the biological information measurement system 10A of the first embodiment as described thus far, the following effects can be achieved.

(1) The biological information measurement system 10A is a system for measuring the biological information of a measurement subject such as a patient. The biological information measurement system 10A includes a plurality of biological information measurement devices 100 that measure a plurality of types of biological information of a specific patient. According to the biological information measurement system 10A, recording biological information that is to be kept as a record of each type of biological information is selected from the plurality of types of biological information measured by the biological information measurement devices 100 based on a predetermined selection standard (in the present embodiment, a standard in which the most recent biological information is selected), as indicated in step S112 of FIG. 4; then, as indicated in step S118 of FIG. 4, the selected recording biological information is recorded in the server 200 so that the recording biological information can be confirmed later.

In this manner, according to the biological information measurement system 10A, a plurality of types of biological information of a specific patient are measured, recording biological information that is to be kept as a record of each type of biological information is selected from the plurality of types of measured biological information based on the predetermined selection standard, and the selected recording biological information is recorded so that the recording biological information can be confirmed later. As a result, highly-reliable biological information can be recorded efficiently and with certainty.

(2) In addition, according to the biological information measurement system 10A, an input confirming whether or not to record the selected recording biological information is accepted, as indicated by step S117 in FIG. 4, and the recording biological information for which an input indicating confirmation has been accepted is then recorded, as indicated by step S118 in FIG. 4.

(3) In addition, the biological information measurement system 10A includes a plurality of biological information measurement devices 100 that each include a plurality of the measurement units 150 and the server 200 that includes the storage unit 220.

(4) In addition, the biological information measurement system 10A includes a plurality of biological information measurement devices 100 that each include a plurality of the measurement units 150, and furthermore, the recording biological information that is to be kept as a record of each type of biological information is selected, by one of the biological information measurement devices 100, from the plurality of types of biological information measured by the biological information measurement devices 100 based on the predetermined selection standard.

(5) In addition, the biological information measurement system 10A includes a plurality of biological information measurement devices 100 that each include a plurality of the measurement units 150, and furthermore, the recording biological information that is to be kept as a record of each type of biological information is selected, by one of the biological information measurement devices 100 (the blood pressure meter 100A, in the present embodiment), from the plurality of types of biological information measured by the biological information measurement devices 100 based on the predetermined selection standard (in the present embodiment, a standard in which the most recent biological information is selected).

(6) Furthermore, the biological information measurement devices 100 include a time measurement function-equipped biological information measurement device (the blood pressure meter 100A, in the present embodiment) and a time measurement function-unequipped biological information measurement device (the thermometer 100B and the pulse oximeter 100C, in the present embodiment). The time measurement function-equipped biological information measurement device identifies a time at which the biological information is measured by the measurement unit 150. Of the recording biological information selected by the host biological information measurement device 100, the server 200 records the identified time as a measurement time of the recording biological information measured by the measurement unit 150 of the time measurement function-equipped biological information measurement device and records a time at which the biological information is sent from the time measurement function-unequipped biological information measurement device to the time measurement function-equipped biological information measurement device as a measurement time of the recording biological information measured by the measurement unit 150 of the time measurement function-unequipped biological information measurement device.

(7) Note that the following configuration may also be employed. The biological information measurement devices 100 include a time measurement function-equipped biological information measurement device (the blood pressure meter 100A, in the present embodiment) and a time measurement function-unequipped biological information measurement device (the thermometer 100B and the pulse oximeter 100C, in the present embodiment). The time measurement function-equipped biological information measurement device identifies a time at which the biological information is measured by the measurement unit 150. Of the recording biological information selected by the host biological information measurement device 100, the server 200 records the identified time as a measurement time of the recording biological information measured by the measurement unit 150 of the time measurement function-equipped biological information measurement device and records a time identified as a biological information measurement time closest to the time at which the biological information is sent from the time measurement function-unequipped biological information measurement device to the time measurement function-equipped biological information measurement device as a measurement time of the recording biological information measured by the measurement unit 150 of the time measurement function-unequipped biological information measurement device.

### Second Embodiment

In the first embodiment, the finalizing candidates are selected in step S112 of FIG. 4 from biological information after the previous finalization and the finalized biological information that has been finalized in step S118 is sent to the server 200, without any particular separation based on time spans. However, in the second embodiment, the finalizing candidates are selected from the biological information for each of a plurality of time spans from after the previous finalization to the present (for example, a plurality of two-hour time spans), after which the finalized biological information is sent to the server 200.

In the second embodiment, in step S112 of FIG. 4, the most recent of each piece of biological information in the history is displayed as a finalizing candidate for each time span.

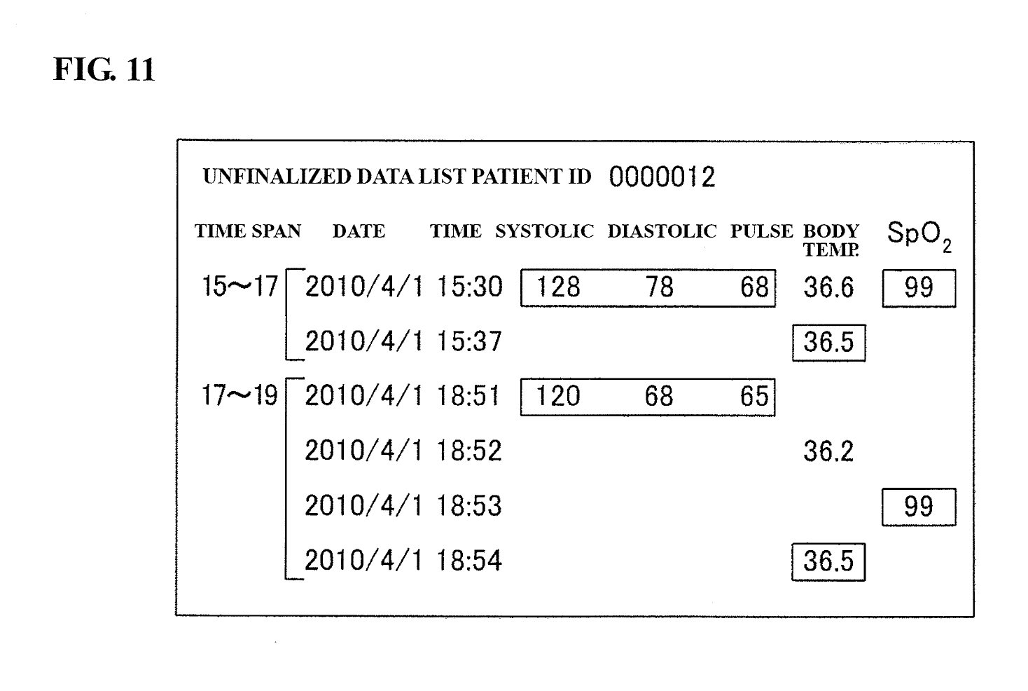

FIG. 11 is a diagram illustrating a screen indicating finalizing candidates displayed in the host biological information measurement device 100, according to the second embodiment. As shown in FIG. 11, here, the measurement history includes history for two time spans, namely a time span from 15:00 to 17:00 and a time span from 17:00 to 19:00, and finalizing candidate biological information is displayed in frames for each of those time spans. Note that the finalizing candidates may be displayed with different colors for the respective time spans.

According to the biological information measurement system of the second embodiment as described thus far, the following effects can be achieved in addition to the effects described in the first embodiment.

(1) The biological information is selected by the biological information measurement system based on a selection standard in which the most recent biological information is selected from each type of biological information on a time span-by-time span basis.

Accordingly, even in the case where it is necessary to measure the biological information on a time span-by-time span basis, the biological information can be automatically selected for a plurality of time spans all at once.

### Third Embodiment

In the first embodiment, the selection of the biological information carried out in step S112 of FIG. 4 is carried out based on a standard in which the most recent biological information is selected. However, in the third embodiment, the selection of the biological information is carried out based on a standard in which biological information having a high reliability, which has been calculated for the measured biological information, is selected.

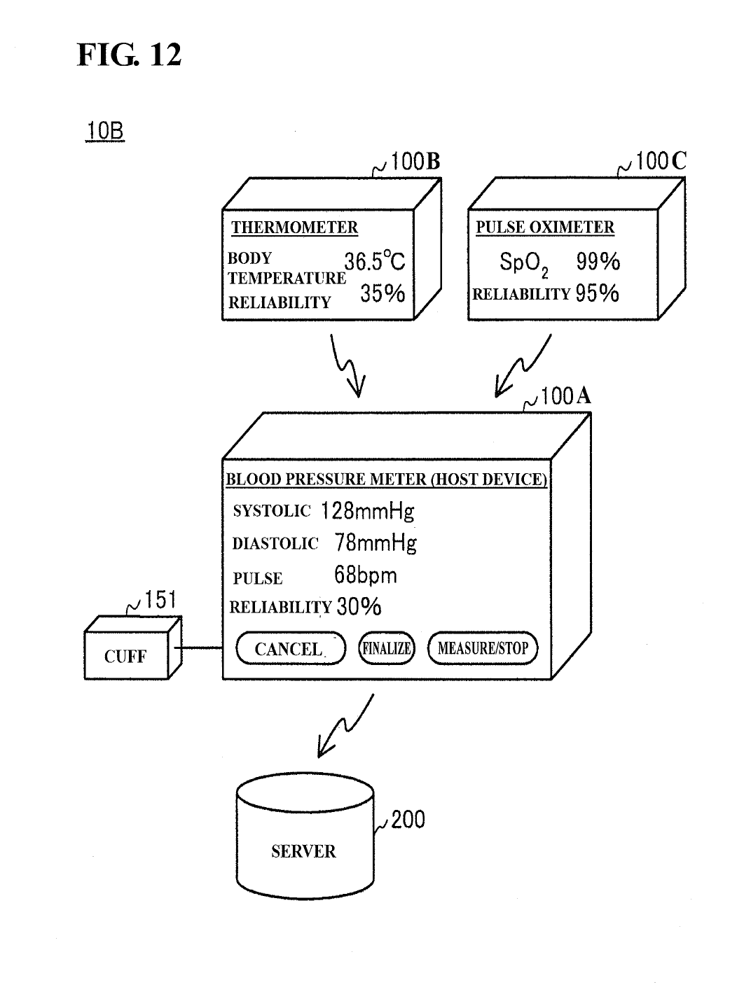

FIG. 12 is a diagram illustrating the system configuration of a biological information measurement system 10B according to the third embodiment. As shown in FIG. 12, in the biological information measurement system 10B according to the third embodiment, the biological information measurement devices 100 included in the biological information measurement system 10A of the first embodiment further calculate a reliability of the biological information measured thereby.

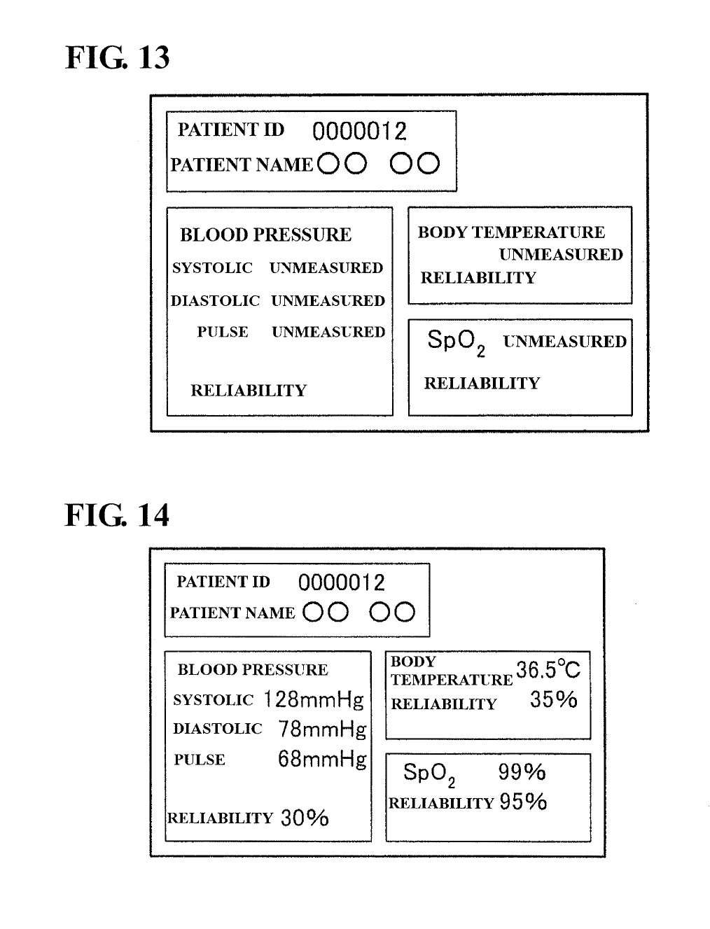

FIG. 13 is a diagram illustrating a screen displayed in the host biological information measurement device 100 when measurements have not been taken, according to the third embodiment. FIG. 14 is a diagram illustrating a screen displayed in the host biological information measurement device 100 when measurements have successfully been taken, according to the third embodiment. As shown in FIGS. 13 and 14, a display region for the reliability of each piece of biological information is provided in addition to the content of the screens illustrated in FIGS. 5 and 6, respectively.

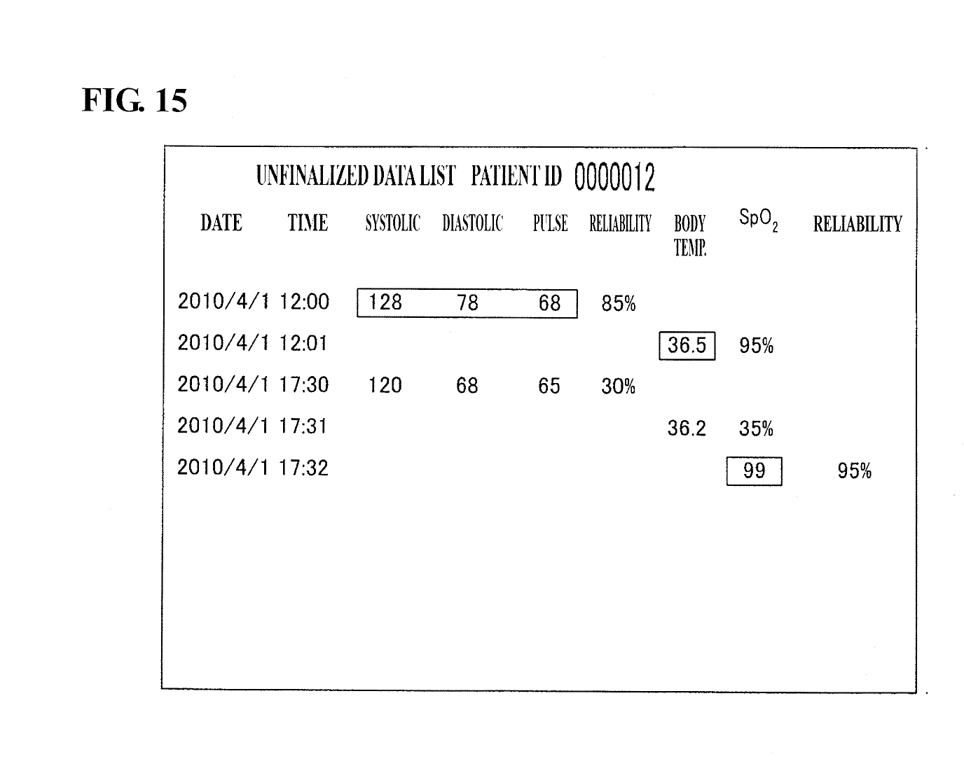

FIG. 15 is a diagram illustrating a screen indicating finalizing candidates displayed in the host biological information measurement device 100, according to the third embodiment. As shown in FIG. 15, the biological information measured by the blood pressure meter 100A (that is, the systolic blood pressure, the diastolic blood pressure, and the pulse) has been measured at 12:00 and 17:30, but because the reliability of the biological information measured at 12:00 is higher, the biological information measured at 12:00 is displayed with a frame, indicating that that biological information is the finalizing candidate.

Meanwhile, the biological information measured by the thermometer 100B (that is, body temperature) has been measured at 12:01 and 17:31, but because the reliability of the biological information measured at 12:01 is higher, the biological information measured at 12:01 is displayed with a frame, indicating that that biological information is the finalizing candidate.

According to the biological information measurement system of the third embodiment as described thus far, the following effects can be achieved in addition to the effects described in the first and second embodiments.

(1) A reliability of the biological information measured by the measurement unit 150 is calculated by the biological information measurement system 10B, and the biological information is selected based on a selection standard in which biological information whose calculated reliability is higher is selected.

Through this, more reliable biological information data can be accumulated in the server 200.

Note that a reliability of the biological information measured by the measurement unit 150 may be calculated by the biological information measurement system 10B, and the biological information may be selected based on a selection standard in which biological information whose calculated reliability is greater than or equal to a predetermined value is selected.

### Variations

Next, variations on the aforementioned embodiments will be described.

(1) In the aforementioned embodiments, the biological information is collected from the respective biological information measurement devices 100 in the case where it is determined that a time for collecting data has been reached, as indicated by step S101 and step S102 in FIG. 4.

However, the invention is not limited thereto; each biological information measurement device 100 may instead measure the biological information and send the measured biological information to the host biological information measurement device 100 at different times, and the host biological information measurement device 100 may collect the sent biological information.

(2) In the aforementioned embodiments, the measurement times of biological information received from the biological information measurement devices 100 that do not have the time measurement function are set to the time at which that biological information has been received by the host biological information measurement device 100 that has the time measurement function.

However, the invention is not limited thereto, and the measurement times of the biological information received from the biological information measurement devices 100 that do not have the time measurement function may be set to the time at which the finalizing operation is made in the host biological information measurement device 100, or may be set to the measurement time of the biological information measured at the time closest to the time at which that biological information has been received by the host biological information measurement device 100 that has the time measurement function.

(3) In the aforementioned embodiments, the biological information received from a plurality of host biological information measurement devices 100 and finalized for each measurement subject is stored in the server 200. However, the invention is not limited thereto, and biological information finalized for each measurement subject and stored in a plurality of servers 200 may further be stored in a higher-level server.

(4) In the aforementioned embodiments, the biological information received from the host biological information measurement device 100 and finalized for each measurement subject is stored in the server 200. However, the invention is not limited thereto, and any of the host biological information measurement devices 100 may be provided with the functionality of the server 200.

(5) In the aforementioned embodiments, the biological information is finalized for each measurement subject by the host biological information measurement device 100 and sent to the server 200, as indicated by step S117 in FIG. 4. However, the invention is not limited thereto, and all of the biological information collected by the host biological information measurement device 100 may be sent to the server 200, after which the biological information may be finalized for each measurement subject in the server 200 and then sent to a server on a higher level than the server 200.

(6) In the aforementioned embodiments, the biological information is collected by the host biological information measurement device 100 from the other biological information measurement devices 100, as indicated by step S117 in FIG. 4. However, the invention is not limited thereto, and the server 200 may carry out the biological information collection performed by the host biological information measurement device 100. In other words, the server 200 may collect the biological information from all of the biological information measurement devices 100.

(7) The aforementioned embodiments describe the invention as a biological information measurement system. However, the invention is not limited thereto, and can also be realized as a method for measuring biological information executed by a biological information measurement system.

Note that the embodiments disclosed above are to be understood as being in all ways exemplary and in no way limiting. The scope of the present invention is defined not by the aforementioned descriptions but by the scope of the appended claims, and all changes that fall within the same essential spirit as the scope of the claims are intended to be included therein as well.

### REFERENCE SIGNS LIST

10A, 10B biological information measurement system

100 biological information measurement device

100A blood pressure meter

100B thermometer

100C pulse oximeter

110 control unit

120 memory

130 operation unit

140 display unit

150 measurement unit

151 cuff

190 communication unit

200 server

210 control unit

220 storage unit

230 operation unit

240 display unit

290 communication unit

900 communication network

1. A biological information measurement system that measures biological information of a patient, the system comprising:
a plurality of measurement means that measure a plurality of types of biological information of a specific patient;
a selection means that selects, from a plurality of pieces of information in each of the plurality of types of biological information measured by the measurement means, recording biological information that is to be kept as a record of each type of biological information, based on a predetermined selection standard; and
a recording means that records the recording biological information selected by the selection means so that the recording biological information can be confirmed later,
wherein the biological information measurement system includes a plurality of measurement devices that each include a plurality of the measurement means;
wherein one of the measurement devices includes:
the selection means;
a display means that displays the recording biological information selected by the selection means so as to be distinguishable from other biological information; and
a confirmation acceptance means that accepts an input confirming whether or not to record the recording biological information displayed by the display means, and
wherein the recording means records the recording biological information for which an input indicating confirmation has been accepted by the confirmation acceptance means.

2. (canceled)

3. The biological information measurement system according to claim 1,
wherein the selection means selects the biological information based on a selection standard in which the most recent biological information is selected from each type of biological information on a time span-by-time span basis.

4. The biological information measurement system according to claim 1, further comprising:
a calculating means that calculates a reliability of the biological information measured by the measurement means,
wherein the selection means selects the biological information based on a selection standard in which biological information whose reliability calculated by the calculating means is greater than or equal to a predetermined value is selected.

5. The biological information measurement system according to claim 1, further comprising:
a server that includes the recording means.

6. (canceled)

7. The biological information measurement system according to claim 1,
wherein the measurement devices include a time measurement function-equipped measurement device and a time measurement function-unequipped measurement device;
the time measurement function-equipped measurement device further includes a time measurement means that identifies a time at which the biological information is measured by the measurement means; and
of the recording biological information selected by the selection means, the recording means records the time identified by the time measurement means as a measurement time of the recording biological information measured by the measurement means of the time measurement function-equipped measurement device and records the time identified by the time measurement means as a measurement time of the recording biological information measured by the measurement means of the time measurement function-unequipped measurement device.

8. The biological information measurement system according to claim 1,
wherein the measurement devices include a time measurement function-equipped measurement device and a time measurement function-unequipped measurement device;
the time measurement function-equipped measurement device further includes a time measurement means that identifies a time at which the biological information is measured by the measurement means; and
of the recording biological information selected by the selection means, the recording means records the time identified by the time measurement means as a measurement time of the recording biological information measured by the measurement means of the time measurement function-equipped measurement device and records a time at which the biological information is sent from the time measurement function-unequipped measurement device to the time measurement function-equipped measurement device as a measurement time of the recording biological information measured by the measurement means of the time measurement function-unequipped measurement device.

9. The biological information measurement system according to claim 5,
wherein the measurement devices include a time measurement function-equipped measurement device and a time measurement function-unequipped measurement device;
the time measurement function-equipped measurement device further includes a time measurement means that identifies a time at which the biological information is measured by the measurement means; and
of the recording biological information selected by the selection means, the recording means records the time identified by the time measurement means as a measurement time of the recording biological information measured by the measurement means of the time measurement function-equipped measurement device and records the time identified by the time measurement means as a measurement time of the recording biological information measured by the measurement means of the time measurement function-unequipped measurement device.

10. The biological information measurement system according to claim 5,
wherein the measurement devices include a time measurement function-equipped measurement device and a time measurement function-unequipped measurement device;
the time measurement function-equipped measurement device further includes a time measurement means that identifies a time at which the biological information is measured by the measurement means; and
of the recording biological information selected by the selection means, the recording means records the time identified by the time measurement means as a measurement time of the recording biological information measured by the measurement means of the time measurement function-equipped measurement device and records a time at which the biological information is sent from the time measurement function-unequipped measurement device to the time measurement function-equipped measurement device as a measurement time of the recording biological information measured by the measurement means of the time measurement function-unequipped measurement device.
